(19) United States
(12) Patent Application Publication
(10) Pub. No.: US 2008/0079204 A1
(43) Pub. Date: Apr. 3, 2008

(54) SELF-ALIGNING AIR-SPRING FOR SUPPRESSING VIBRATIONS

(75) Inventors: Baruch Pletner, Newton, MA (US); Grace Rose Kessenich, Somerville, MA (US)

Correspondence Address: Vista IP Law Group LLP, 9th Floor, 2040 Main Street, Irvine, CA, 92614, US

(73) Assignee: IPTRADE, INC., Newton, MA (US)

(21) Appl. No.: 11/530,877

(22) Filed: Sep. 11, 2006

Related U.S. Application Data
(60) Provisional application No. 60/822,919, filed on Aug. 18, 2006.

(51) Int. Cl. B60G 17/00

(52) U.S. Cl. 267/64.17

(57) ABSTRACT

A gas spring for suppression vibrations in payloads is provided. The gas spring comprises a piston disposed within the housing. The piston is configured to be displaced relative to the housing in response to vibrations applied to the housing. The piston has first concave or convex surface and a second surface opposing the first surface. The housing is configured to allow a first gaseous medium to apply a first gas pressure to the first concave piston surface, and a second gaseous medium to apply a second gas pressure to the second piston surface, thereby resulting in a net gas pressure force applied to the piston.

### CROSS REFERENCE TO RELATED APPLICATION

This present application claims priority from U.S. Provisional Application Ser. No. 60/822,919, filed Aug. 18, 2006. This application is filed concurrently with U.S. patent application Ser. No. 11/xxx,xxx (VIP Docket No. IPT-004(1)), entitled “Dynamic Equilibrium Air Spring for Suppressing Vibration” and U.S. patent application Ser. No. 11/xxx,xxx (VIP Docket No. IPT-004(2)), entitled “Air Spring with Magneto-Rheological Fluid Gasket for Suppressing Vibrations”, the disclosure of which are expressly incorporated herein by reference.

### FIELD OF THE INVENTION

The present inventions generally relate to the analysis and suppression of structural vibrations in apparatus and systems.

### BACKGROUND OF THE INVENTION

Structural vibration is one of the key performance limiting phenomena in many types of advanced machinery, such as space launch vehicle shrouds, all types of jet and turbine engines, robots, and many types of manufacturing equipment. For example, semiconductor manufacturing equipment and the equipment used to manufacture micro- and nano-devices are sensitive to structural vibration at ever increasing levels. The positioning accuracy requirements in the most advanced semiconductor manufacturing and test equipment in the market today are on the order of single-digit nanometers.

There are various solutions that exist for suppressing structural vibrations within manufacturing equipment. One solution involves locating passive springs between the manufacturing equipment and the structure on which the machinery is mounted, so that any vibration induced within the mounting structure is suppressed or dampened by the springs. These springs may take the form of mechanical springs or gas springs. Significant to the present invention is a gas spring.

In a gas spring, sensitive equipment “rides” on a cushion of pressurized gas (e.g., air) contained within a cylinder chamber mounted to a supporting structure susceptible to vibration. The cushion of pressurized air serves as a spring that dampens any vibrations transmitted from the supporting structure to the air spring via the cylinder. Typically, gas can be introduced into or removed from the cylinder chamber to set the static equilibrium point of the gas spring, and in particular, to set the nominal position of the sensitive equipment relative to the gas spring cylinder during a static condition (i.e., no vibrational force is applied to the gas spring). During a dynamic condition (i.e., vibrations forces are applied to the gas spring), the sensitive equipment will be displaced from the nominal position, thereby suppressing the vibrations otherwise transmitted to the sensitive equipment, and will return to the nominal displacement during the static condition; i.e., the gas spring will return to equilibrium.

Significantly, the ability of a gas spring to attenuate vibrations will logarithmically increase as the frequency of the vibration increases relative to the natural frequency of the gas spring (when supporting a payload). Because there is little control over the vibration frequency, the natural frequency of the payload supporting spring must be designed, and preferably minimized, to maximize the vibration attenuation—especially at low vibration frequencies. In some cases, a gas spring may actually amplify the vibrations if the natural frequency of the spring is substantially higher than the vibration frequency. Thus, a premium is placed on minimizing the natural frequency of a spring.

The natural frequency of a spring may be characterized by the following equation:

$${f}_{n} = \sqrt{\frac{k}{m}} ,$$

where fₙ is the natural frequency of the spring, k is the stiffness constant of the spring, and m is the mass of the payload supported by the spring. It can be appreciated from this equation that the natural frequency of a payload supporting spring can be reduced by decreasing its stiffness constant. Because a spring must have a finite stiffness to support the static weight of the payload, however, there is a limit on how much the stiffness constant can be reduced. That is, as the mass of the payload increases, the stiffness constant of the spring must accordingly increase.

Another limitation that prior art vibration suppression systems have is the possibility of damage to the payload during abnormal operating conditions, such as the occurrence of intense vibrations (e.g., caused by an earthquake) or failure of the gas spring (e.g., depressurization of the chamber). In such cases, it is possible for severe vibrations or failure of the chamber to cause the rigid component to which the payload is mechanically to firmly contact the wall of the cylinder chamber. The resulting impact may destroy, or otherwise damage, the sensitive equipment. In the case of sensitive equipment that is costly and/or difficult to replace (e.g., the lens component within semiconductor manufacturing equipment), the production line may need to be halted until the sensitive equipment is replaced, thereby incurring consequential costs, as well as the cost needed to replace the sensitive equipment. It is possible for the vibration suppression system in which the gas spring is incorporated to include safety features that prevent damage to the sensitive equipment during abnormal operating conditions. However, each time the safety features are activated, the vibration suppression system needs to be reset—a non-trivial step that may require hours to perform.

Still another limitation that prior art vibration suppression systems have is the inability to stabilize the sensitive equipment within the inertial reference frame (reference frame tied to the earth's gravity) in all 6 degrees-of-freedom (i.e., displacement along the X-, Y-, and Z-axes, rotation about the X-axis (pitch), Y-axis (roll), and Z-axis (yaw)). Because structure vibrates in all 6-degrees-of-freedom, however, it is possible that these prior art vibration suppression systems will not suppress all of the vibrational forces. In fact, many air springs are only capable of suppressing vibrational forces in the Z-direction.

Yet another limitation that prior art vibration suppression systems have is the inability to independently orient the air springs within the inertial reference frame. That is, typical gas springs are designed to be oriented in a specific manner based on the direction of the force exerted by the weight of the payload. For example, a typical gas spring that supports a payload in compression cannot be flipped around to support the payload in suspension.

Thus, there remains a need for an orientation independent vibration suppression system that efficiently isolates a payload from vibrational forces within the inertial reference frame in all 6 degrees-of-freedom during normal operating conditions, while preventing damage to the payload during abnormal operating conditions.

### SUMMARY OF THE INVENTION

In accordance with the present inventions, a gas spring is provided. The gas spring comprises a housing and a piston (e.g., a cylindrical piston) disposed within the housing. The piston is configured to be displaced relative to the housing in response to vibrations applied to the housing. The piston has a first surface adjacent the first chamber and a second surface opposing the first surface, wherein a first gaseous medium applies a first gas pressure to the first piston surface, and a second gaseous medium applies a second gas pressure to the second piston surface, thereby resulting in a net gas pressure force applied to the piston. In one embodiment, the housing has a first chamber adjacent the first piston surface for containing the first gaseous medium, and a second chamber adjacent the second piston surface for containing the second gaseous medium.

In accordance with a first aspect of the present inventions, the first surface is concave (e.g., spherical or lens-shaped). In an exemplary embodiment, the second surface is also concave. Although the present inventions should not be so limited in their broadest aspects, the forces applied to the concave surface(s) by the first or second gas pressures is such that the piston self-aligns with the housing if the housing becomes misaligned to an inertial reference frame in response to vibrations.

In accordance with a second aspect of the present inventions, the first surface is convex (e.g., spherical or lens-shaped). In an exemplary embodiment, the second surface is also convex. Although the present inventions should not be so limited in their broadest aspects, the forces applied to the convex surface(s) by the first or second gas pressures is such that the piston remains aligned with the inertial reference frame if the housing becomes misaligned to the inertial reference frame in response to vibrations.

In accordance with a third aspect of the present inventions, a vibration suppression system is provided. The vibration suppression system comprises the previously described gas spring (with concave piston surface or convex piston surface) and a payload (e.g., manufacturing equipment) mechanically coupled to the piston of the gas spring. In one embodiment, the housing has a first chamber adjacent the first piston surface for containing the first gaseous medium, and the system further comprises a pressure control subsystem configured to modify the mass of the first gaseous medium within the first chamber to equalize the net gas pressure force when modified in response to a displacement of the piston relative to the housing.

Other and further aspects and features of the invention will be evident from reading the following detailed description of the preferred embodiments, which are intended to illustrate, not limit, the invention.

### BRIEF DESCRIPTION OF THE DRAWINGS

The drawings illustrate the design and utility of preferred embodiments of the present invention, in which similar elements are referred to by common reference numerals. In order to better appreciate how the above-recited and other advantages and objects of the present inventions are obtained, a more particular description of the present inventions briefly described above will be rendered by reference to specific embodiments thereof, which are illustrated in the accompanying drawings.

Understanding that these drawings depict only typical embodiments of the invention and are not therefore to be considered limiting of its scope, the invention will be described and explained with additional specificity and detail through the use of the accompanying drawings in which:

FIG. 1 is a plan view of a vibration suppression system constructed in accordance with one preferred embodiment of the present inventions;

FIG. 2 is a cross-sectional, perspective view, of a gas spring used in the vibration suppression system of FIG. 1;

FIG. 3 is a block diagram of a control subsystem used in the vibration suppression system of FIG. 1;

FIG. 4 is an alternative embodiment of a piston that can be used in the gas spring of FIG. 2;

FIG. 5 is another alternative embodiment of a piston that can be used in the gas spring of FIG. 2;

FIG. 6 is still another alternative embodiment of a piston that can be used in the gas spring of FIG. 2;

FIGS. 7a and 7b are diagrams illustrating the forces applied by gas pressure to a conventional piston of FIG. 4;

FIGS. 8a and 8b are diagrams illustrating the forces applied by gas pressure to the piston of FIG. 4;

FIGS. 9a and 9b are diagrams illustrating the forces applied by gas pressure to the piston of FIG. 6; and

FIG. 10 is a free-body diagram of forces applied to a payload within the vibration suppression system of FIG. 1.

### DETAILED DESCRIPTION OF THE EMBODIMENTS

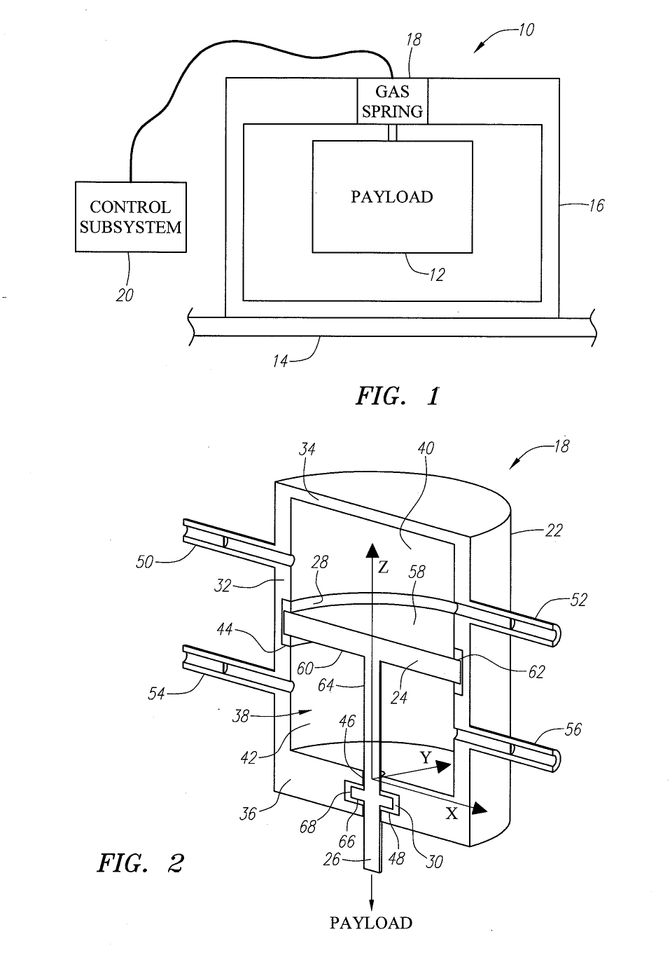

Referring to FIG. 1, a vibration suppression system 10 constructed in accordance with one embodiment of the present inventions is described. The system 10 is designed to fully support the static weight of the payload, while minimizing the time-dependent component of the weight of a payload 12 by suppressing vibrational forces that may otherwise adversely affect the performance of the payload 12; that is, by maintaining the payload 12 stationary with respect to an inertial reference frame. The vibration suppression system 10 is capable of effectively suppressing vibrations within the range of just above 0 to 100 Hertz and vibrations with displacements within any range. During normal operating conditions, the vibration suppression system 10 is capable of suppressing the vibrational forces along the X-, Y-, and Z-axes and about the Z-axis (yaw) of the inertial reference frame, and optionally, is capable of suppressing the vibrational forces about the X- and Y-axes (pitch and roll) of the inertial reference frame. During the abnormal operating conditions, the vibration suppression system 10 is also capable of dampening any force that could potentially damage the payload 12 during abnormal operating conditions.

The payload 12 may comprise any type of equipment having a performance that is highly sensitive to vibrational force. In the illustrated embodiment, the payload 12 comprises manufacturing equipment or a component thereof (e.g., the lens of semiconductor manufacturing equipment) located on a floor 14, although the system 10 or variations thereof can be used to suppress vibrations in other types of payloads, such as rocket payloads or jet and turbine engines. While the floor 14 statically supports the payload 12, the system 10 is designed to isolate the payload 12 from the dynamic forces, and in particular, vibrational forces that may occur in the floor 14. Such vibrational forces may, e.g., originate from other equipment (not shown) located on the floor 14.

The system 10 generally includes a (1) support structure (e.g., a frame 16) below which the payload 12 is suspended above the floor 14; (2) a gas spring 18, which serves as the mechanical mechanism that isolates the payload 12 from any vibrational force that travels from the floor 12 through the support structure 16; and (3) a control subsystem 20, which serves to dynamically control the mass of a gaseous medium (such as air) contained within the gas spring 18 to maximize the vibration suppression capability of the gas spring 18 during normal operating conditions, as well as to prevent or minimize any damage to the payload 12 during abnormal operating conditions.

The support structure 16 can be any rigid mechanical structure capable of supporting the weight of the payload 12 and preventing the payload 12 from directly contacting the floor 14. The support structure 16 can be part of the manufacturing equipment that is not sensitive to vibrational forces or can be a structure that is completely independent of the manufacturing equipment; that is, it functions only to support the payload 12. In the illustrated embodiment, the support structure 16 suspends the payload 12 above the floor 14. In other embodiments, the payload 12 may be supported atop the frame 16 above the floor 14. In still other embodiments, a frame (not shown) may be mounted to other structures through which vibrational forces may be conducted to the payload 12. For example, the frame may be mounted to a ceiling susceptible to vibrational forces, in which case, the payload 12 will be suspended from the ceiling. As another example, the frame may be mounted to a lateral wall susceptible to vibrational forces, in which case, the payload 12 may be located adjacent to the lateral wall. In still other embodiments, a support structure 16 is not used—instead, the gas spring 18 is mounted directly to the floor 14 and the payload 12 is mounted atop of the gas spring 18. Ultimately, the manner in which the payload 12 is supported will depend largely on the nature of the payload 12 and the environment in which the payload 12 operates.

Referring now to FIG. 2, the features of the gas spring 18 will be described in detail. The gas spring 18 illustrated in FIG. 2 passively suppresses the vibrational forces along the X- and Y-axes and about the Z-axis of the inertial reference frame, and under the influence of the control subsystem 20, actively suppresses the vibrational forces along the Z-axis of the inertial reference frame; that is, the gas spring 18 stabilizes the payload 12 to the inertial reference frame in four degrees-of-freedom. To this end, the gas spring 18 generally comprises a cylinder 22 (a hollow cylinder in the illustrated embodiment), a piston 24 (i.e., a piston head) and a piston rod 26 disposed within the cylinder 22, a piston gasket 28 located between the cylinder 22 and the piston 24, and a rod gasket 30 located between the cylinder 22 and the piston rod 26.

The cylinder 22 has a cylinder body 30 having a side wall 32, a top wall 34, and a bottom wall 36 that contain a cavity 38 therein. The cylinder body 30 may be composed of any suitable rigid material, such as aluminum or stainless steel. The cavity 38 is topologically divided by the piston 24 into an upper chamber 40 and a lower chamber 42, each of which contains a gaseous medium (e.g., air). While the cavity 38 can have any one of a variety of shapes, the cavity 38, and thus, the upper and lower chambers 40, 42, are preferably generally cylindrical. As can also be seen in FIG. 2, the diameter of the cylindrical cavity 38 is generally uniform, and thus, the upper and lower chambers 40, 42 have the same diameters. In alternative embodiments, however, the upper and lower chambers 40, 42 may have different diameters—although it is preferred that the cylinder chambers 40, 42 have the same diameter for each of manufacturability and operational simplicity.

The cylinder 22 further includes an upper annular recess 44 formed within the side wall 32 of the cylinder body 30 in which the piston gasket 28 is seated. The cylinder 22 also includes a bore 46 formed within the bottom wall 36 of the cylinder body 30 through which the piston rod 26 passes, and a lower annular recess 48 formed within the bore 46 in which the rod gasket 30 is seated. The cylinder 22 further includes a high pressure inlet port 50 and a low pressure outlet port 52 through which a gaseous medium (e.g., air) can be conveyed between the upper chamber 40 and the control subsystem 20, and a high pressure inlet port 54 and a low pressure outlet port 56 through which a gaseous medium (e.g., air) can be conveyed between the lower chamber 42 and the control subsystem 20, as will be described in further detail below.

The piston 24 may be composed of a suitable rigid material, such as aluminum or stainless steel. In the illustrated embodiment, the piston 24 and piston rod 26 are molded into a unibody structure, although, in alternative embodiments, the piston 24 and piston rod 26 may be separately fabricated and then coupled together using suitable means, such as welding. The piston 24 has an upper surface 58 adjacent the upper chamber 40 and a lower surface 60 adjacent the lower chamber 42. Thus, the gaseous medium contained with the upper chamber 40 has a pressure that applies a downward force on the upper piston surface 58, and the gaseous medium contained within the lower chamber 42 has a pressure that applies an upward force on the lower piston surface 60, thereby resulting in a net gas pressure force applied to the piston 24, and thus, the payload 12.

In the illustrated embodiment, the piston 24 is cylindrically shaped and has a diameter that is greater than the diameter of the cylinder cavity 38, so that the outer circumference of the piston 24 is disposed within the upper cylinder recess 44. The piston gasket 28 is ring-shaped and includes an annular recess 62 in which the piston 24 is seated. To this end, the piston 24 has a diameter that conforms to the diameter of the annular recess 62 within the piston gasket 28, and a thickness that conforms to the thickness of the upper cylinder recess 44, so that the piston gasket 28 snugly fits therein. The piston 24 has a thickness less than the thickness of the upper cylinder recess 44, so that the piston 24 is free to move up or down.

The piston rod 26 includes a shaft 64 and an annular flange 66. The rod shaft 68 has a length suitable to extend from the piston 24 and through the bore 46 to the exterior of the cylinder body 30. The payload 12 may be rigidly mounted to the exposed end of the rod shaft 68 using any suitable means, such as welding or via fasteners, such as screws or bolts. In the illustrated embodiment, the annular rod flange 66 is cylindrically shaped and has a diameter that is greater than the diameter of the housing bore 46, so that the outer circumference of the annular rod flange 66 is disposed within the lower cylinder recess 48. The rod gasket 30 is ring-shaped and includes an annular recess 68 in which the annular rod flange 66 is seated. To this end, the annular rod flange 66 has a diameter that conforms to the diameter of the annular recess 68 within the rod gasket 30, and a thickness that conforms to the thickness of the lower cylinder recess 48, so that the piston gasket 28 snugly fits therein. The annular rod flange 66 has a thickness less than the thickness of the lower cylinder recess 48, so that the annular rod flange 66 is free to move up or down.

Thus, the piston gasket 28 functions to fluidly isolate (i.e., seal) the upper chamber 40 and the lower chamber 42 from each other, and the rod gasket 30 functions to fluidly isolate (i.e., seal) the lower chamber 42 from the exterior of the cylinder 22. As will be described in further detail below, the piston gasket 28 takes the form of a magneto-rheological (MR) fluid gasket that allows the piston 24 to be freely displaced within the cylinder cavity 38 (i.e., move up or down within the upper cylinder recess 44) in response to vibrations conveyed to the cylinder 22, while preventing the piston 24 from firmly contacting the respective upper and lower surfaces (i.e., the rails) of the upper cylinder recess 44 indirectly through the piston gasket 28. Like the piston gasket 28, the rod gasket 30 may take the form of a MR fluid gasket, or alternatively, may take the form of a standard fluid gasket that includes a thin membrane containing a highly viscous fluid.

While the piston gasket 28 and rod gasket 30 are preferably highly viscous during normal operating conditions, the piston gasket 28 and rod gasket 30 may respectively apply some force to the respective piston 24 and annular rod flange 66. That is, the lower portion of the piston gasket 28 (i.e., the portion below the annular gasket recess 62) may apply an upward force on the lower piston surface 60, and the upper portion of the piston gasket 28 (i.e., the portion above the annular gasket recess 62) may apply a downward force on the upper piston surface 58. Similarly, the lower portion of the rod gasket 30 (i.e., the portion below the annular gasket recess 68) may apply an upward force on the annular rod flange 66, and the upper portion of the rod gasket 30 (i.e., the portion above the annular gasket recess 68) may apply a downward force on the upper piston surface 58. Due to the viscous nature of the gaskets 28, 30, the gasket forces acting on the piston 24 and piston rod 26, and thus, the payload 12, will be minimal during normal operating conditions.

The dimensions of the various components in the gas spring 18 will ultimately depend, at least in part, on the weight of the payload 12 that the gas spring 18 supports. In one exemplary embodiment, the cylinder cavity 38 has a height of 240 mm and a diameter of 200 mm. The upper cylinder recess 44, and thus the piston gasket 28, has a height of 40 mm. As a result, the height of each of the upper and lower chambers 40, 42 is approximately 100 mm, depending on the relative displacement between the piston 24 and the cylinder 22. The piston 24 has a thickness of 20 mm, leaving 10 mm of the piston gasket 28 on either side of the piston 24. The upper cylinder recess 44, and thus the piston gasket 28, has diameter of 220 mm. The piston 24 has a diameter of 218 mm, leaving 1 mm of clearance between it and the housing side wall 32 within the upper cylinder recess 44.

As briefly discussed above, the gas spring 18, during normal operating conditions, provides four degree-of-freedom inertial stabilization for the payload 12. In particular, rotation about the Z-axis and translation along X- and Y-axes of the inertial reference frame is prevented by the soft spring behavior of the piston gasket 28 (and optionally the rod gasket 30). As will be described in further detail below, translation along the Z-axis of the inertial frame is prevented by the operation of the control subsystem 22. Stabilization of the payload 12 within the inertial reference frame can only be accomplished by displacing or rotating the piston 24 relative to the vibrating cylinder 22. Thus, the payload 12 is decoupled from the reference frame of the cylinder 22 (or floor 14) and coupled to the inertial reference frame. Of course, during abnormal operating conditions, the transformation of the MR fluid into a solid overwhelms the factors that would normally inertially stabilize the payload 12. As a result, the piston 24 will be displaced or rotated with the vibrating cylinder 22, thereby decoupling the payload 12 from the inertial reference frame and coupling the payload 12 to the reference frame of the cylinder 22 (or floor 14).

While the upper and lower piston surfaces 58, 60 illustrated in FIG. 2 are flat, and therefore, do not self-stabilize the piston 24 within the cylinder chamber 38 when the cylinder 22 rotates about the X-axis (pitch) or about the Y-axis (roll). For example, referring to FIG. 7a, when the cylinder 22 is aligned with the inertial reference frame (z-axis of cylinder reference frame is aligned with Z-axis of inertial reference frame), and the piston 24 is aligned within the cylinder 22, the net force applied by the gaseous medium in the upper cylinder chamber 40 to the upper piston surface 58 only has a component along the z-axis of the cylinder reference frame. As a result, the piston 24, and thus the payload 12, remains aligned with the Z-axis of the inertial reference frame. Referring to FIG. 7b, when the cylinder 22 becomes misaligned with the inertial reference frame (due to vibrations from the floor 14), the net force applied by the gaseous medium in the upper cylinder chamber 40 to the upper piston surface 58 has a component along the x-axis of the cylinder frame. This force provides a returning force that attempts to align the piston 24 with the cylinder 22. As a result, the returning force will cause the piston 24, and thus the payload 12, to misalign with the Z-axis of the inertial reference frame. Notably, the returning force is not great enough to fully align the piston 12 with the cylinder 22, and therefore, the payload 12 will be misaligned with the cylinder reference frame as well. Thus, in this case, the piston 12 will not self-stabilize to either of the inertial reference frame or the cylinder reference frame.

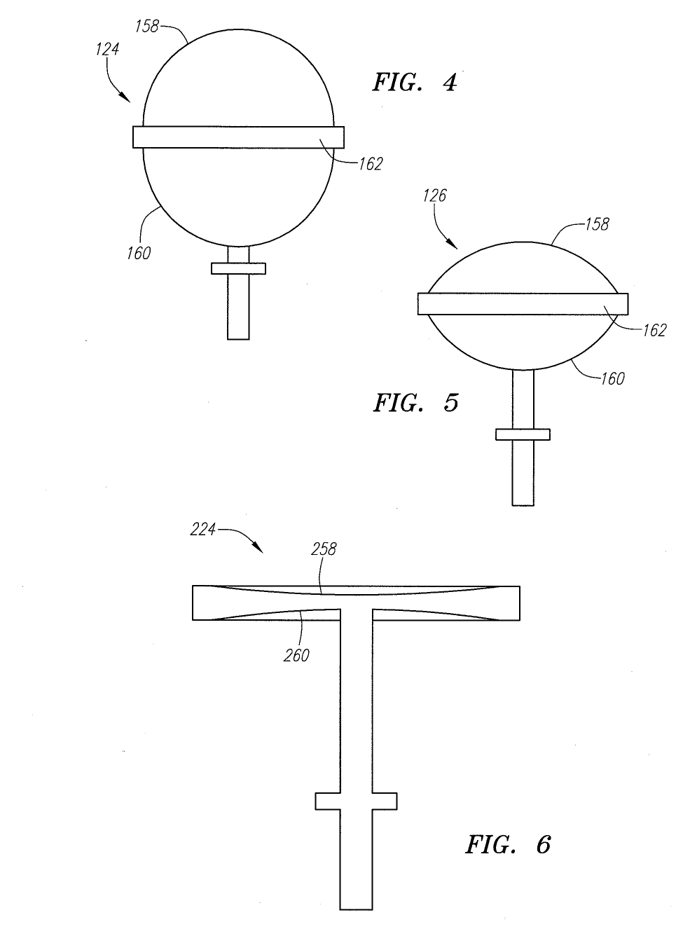

However, the gas spring 18 can alternatively be designed with a piston that inherently self-stabilizes to the inertial reference frame. In this case, the vibrational forces about the X- and Y-axes (pitch and roll) of the inertial reference frame will be suppressed; that is, the gas spring 18 stabilizes the payload 12 to the inertial reference frame in all six degrees-of-freedom. With reference to FIGS. 4 and 5, different self-stabilizing pistons 124, 126, each having upper and lower convex surfaces 158, 160, are provided. In FIG. 4, the convex surfaces 158, 160 are spherically shaped to maximize the self-stabilizing function, whereas in FIG. 5, the convex surfaces 158, 160 are lens-shaped, which provides a compromised self-stabilizing function, but may be desirable to comply with other design considerations—particularly size. In both cases, a lip 130 is provided, so that the piston 124 can interact with the piston gasket 44; that is, the lip 130 can be disposed within the annular gasket recess 62 (shown in FIG. 2).

Thus, referring to FIG. 8a, when the cylinder 22 is aligned with the inertial reference frame (z-axis of cylinder reference frame is aligned with Z-axis of inertial reference frame), and the piston 124 is aligned within the cylinder 22, the net force applied by the gaseous medium in the upper cylinder chamber 40 to the upper piston surface 158 only has a component along the z-axis of the cylinder reference frame. As a result, the piston 124, and thus the payload 12, remains aligned with the Z-axis of the inertial reference frame. Referring to FIG. 8b, when the cylinder 22 becomes misaligned with the inertial reference frame (due to vibrations from the floor 14), the force applied by the gaseous medium in the upper cylinder chamber 40 to the upper piston surface 158 still only has a component along the z-axis of the cylinder reference frame. Since there is no returning force that attempts to align the piston 124 with the cylinder 22, the piston 124, and thus the payload 12, will remain aligned with the Z-axis of the inertial reference frame.

The gas spring 18 can alternatively be designed with a piston that inherently self-stabilizes to the cylinder reference frame. With reference to FIG. 7, another self-stabilizing piston 224 having upper and lower concave surfaces 258, 260 are provided. In FIG. 7, the concave surfaces 258, 260 are spherically shaped to maximize the self-stabilizing function, although, the concave surfaces 258, 260 may alternatively be lens-shaped.

While the upper and lower piston surfaces 58, 60 illustrated in FIG. 2 are flat, and therefore, do not self-stabilize the piston 24 within the cylinder chamber 38 when the cylinder 22 rotates about the X-axis (pitch) or about the Y-axis (roll). For example, referring to FIG. 9a, when the cylinder 22 is aligned with the inertial reference frame (z-axis of cylinder reference frame is aligned with Z-axis of inertial reference frame), and the piston 224 is aligned within the cylinder 22, the net force applied by the gaseous medium in the upper cylinder chamber 40 to the upper piston surface 258 only has a component along the z-axis of the cylinder reference frame. As a result, the piston 224, and thus the payload 12, remains aligned with the Z-axis of the inertial reference frame. Referring to FIG. 9b, when the cylinder 22 becomes misaligned with the inertial reference frame (due to vibrations from the floor 14), the net force applied by the gaseous medium in the upper cylinder chamber 40 to the upper piston surface 258 has a large component along the x-axis of the cylinder frame. This force provides a strong returning force that will align the piston 24 with the cylinder 22, and will thus, align the payload 12 with the cylinder reference frame.

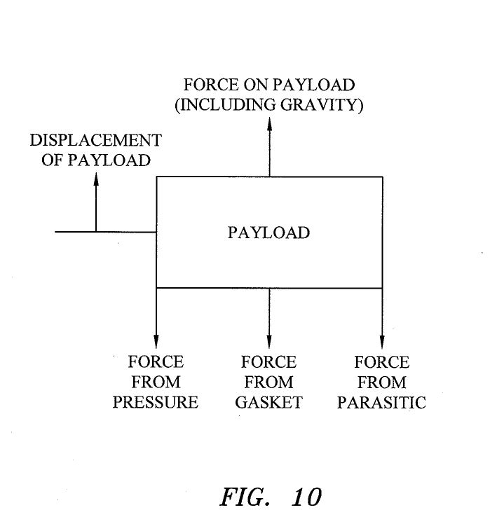

Before discussing the control subsystem 20, it will be instructive to discuss the forces that may be applied to the payload 12 at any given moment. As illustrated in FIG. 10, the sum of the forces applied to the piston 24, and thus the payload 12, may be represented by the equation:

F_{payload}=Fₚᵣₑₛₛᵤᵣₑ+F_{gasket}+F_{parasitic}−F_{gravity}, [1]

where F_{payload} is the net force applied to the payload; Fₚᵣₑₛₛᵤᵣₑ is the force applied to the payload 12 by gaseous media in the upper and lower cylinder chambers 40, 42 (i.e., the net gas pressure force); F_{gasket} is the force applied to the payload 12 by the piston and rod gaskets 28, 30; F_{parisitic} is the force applied to the payload 12 by inherent viscous and elastic behavior originating from the interfaces of different components and stiffness of materials; and F_{gravity} is the force applied to the payload 12 by gravity.

The displacement of the payload 12 in the inertial reference frame can be found by integrating the acceleration of the payload 12 twice. Thus, ignoring the mass of the piston 24, which will typically be much less than the payload 12 that it supports, the displacement of the payload 12 may be represented by the equation:

$${Z}_{payload} = \int \int \frac{{F}_{payload}}{{M}_{payload}} , \qquad [ 2 ]$$

where Z_{payload} is the displacement of the payload 12 in the inertial reference frame; F_{payload} is the net force applied to the payload 12, as provided in equation [1]; and M_{payload} is the mass of the payload 12 (ignoring the mass of the piston 24, which will typically be much less than the payload 12 that it supports).

During a steady state condition, wherein no vibrations are transmitted to the gas spring 18 by the floor 14, the various forces applied to the payload 12 will balance out, resulting in a net force F_{payload}, and thus a displacement Z_{payload}, that is zero. As a result, the relative displacement between the piston 24 and the cylinder 22 remains at a static equilibrium point. During a dynamic condition, wherein vibrations are transmitted to the gas spring 18 by the floor 14, the various forces applied to the payload 12, and primarily the pressure forces, become imbalanced, resulting in a net force F_{payload}, and thus a displacement Z_{payload}, that is non-zero.

In particular, as vibrations are transmitted to the gas spring 18, the cylinder 22 will be displaced upward and downward in the inertial reference frame (along the Z-axis) at the frequency of the vibrations. When the cylinder 22 is displaced upward, the piston 24 will lag behind. In effect, the piston 24 is displaced downward relative to the cylinder 22 from the static equilibrium point, thereby decreasing the pressure of the gaseous medium in the upper cylinder chamber 40, and increasing the pressure of the gaseous medium in the lower cylinder chamber 42. As a result, the net gas pressure force Fₚᵣₑₛₛᵤᵣₑ applied to the piston 24 is increased in the upward direction, creating a returning force that causes the piston 24, and thus, the payload 12, to be displaced upward in the inertial reference frame back to the static equilibrium point if the net gas pressure force Fₚᵣₑₛₛᵤᵣₑ is not equalized (i.e., returned back to its value at static equilibrium). Similarly, when the cylinder 22 is displaced downward, the piston 24 will lag behind. In effect, the piston 24 is displaced upward relative to the cylinder 22, thereby increasing the pressure of the gaseous medium in the upper cylinder chamber 40, and decreasing the pressure of the gaseous medium in the lower cylinder chamber 42. As a result, the net gas pressure force Fₚᵣₑₛₛᵤᵣₑ applied to the piston 24 is increased in the downward direction, creating a returning force that causes the piston 24, and thus, the payload 12, to be displaced downward in the inertial reference frame back to the static equilibrium point if the net gas pressure force Fₚᵣₑₛₛᵤᵣₑ is not equalized (i.e., returned back to its value at static equilibrium).

The control subsystem 20 functions to minimize the net force F_{payload} and displacement Z_{payload} by actively modifying the mass of the gaseous media (and thus, the density and pressure) in the respective upper and lower cylinder chambers 40, 42 in response to the displacement of the piston 24 relative to the cylinder 22 to equalize the net gas pressure force Fₚᵣₑₛₛᵤᵣₑ applied to the piston 24, thereby stabilizing the payload 12 along the Z-axis of the inertial reference frame. This creates a new equilibrium position of the piston 24 relative to the cylinder 22 (or floor 14), but the same equilibrium position in the inertial reference frame; that is, the payload 12 is displaced relative to the cylinder 22, but not relative to the inertial reference frame. In effect, the gas spring 18 re-creates a new equilibrium for any position of the piston 24 relative to the cylinder 22.

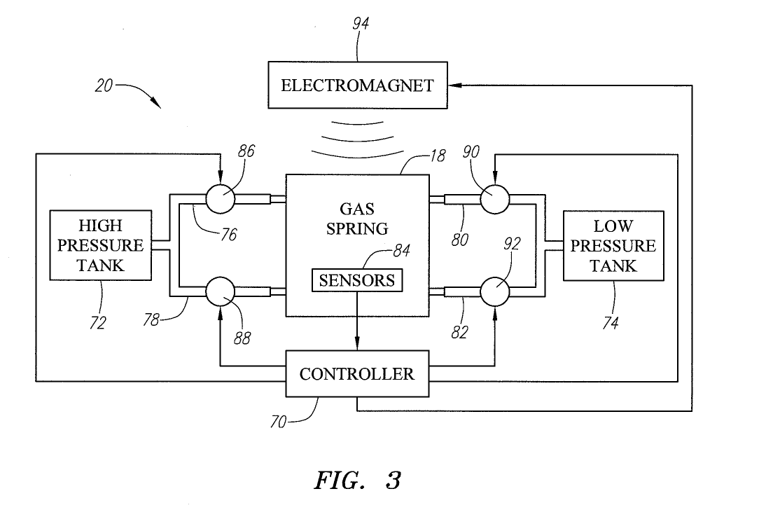

Referring now to FIG. 3, the control subsystem 20 will now be described in further detail. The control subsystem 20 generally includes a controller 70, a high pressure source 72 fluidly coupled to the gas spring 18 via conduits 76, 78 respectively connected to the high pressure ports 50, 54 of the gas spring 18, a low pressure source 74 fluidly coupled to the gas spring 18 via conduits 80, 82 respectively connected to the low pressure ports 52, 56 of the gas spring 18, and one or more sensors 84 for measuring the displacement of the piston 24 relative to the cylinder 22.

The high pressure source 72 takes the form of a tank that contains a gaseous medium at a pressure higher than the expected maximum gas pressure in either of the upper and lower cylinder chambers 40, 42 of the gas spring 18. The low pressure source 74 takes the form of a tank that contains a gaseous medium at a pressure lower than the expected minimum gas pressure in either of the upper and lower cylinder chambers 40, 42 of the gas spring 18. In practice, the gas pressure in the lower cylinder chamber 42 will always be higher than the gas pressure in the upper cylinder chamber 40 in order to counteract the weight of the payload 12.

Each of the sensors 84 can take the form of any sensor capable of measuring the displacement between objects. In the embodiment illustrated in FIG. 4, the sensors 84 are capacitive sensors mounted on the upper piston surface 58 to provide proximity measurements between the upper piston surface 58 to the upper surface of the upper cylinder recess 44 (shown in FIG. 2), thereby providing a means for determining the displacement of the piston 24 relative to the cylinder 22. In the illustrated embodiment, the sensors 84 are spaced equally around the outer region of the upper piston surface 58 to provide multiple proximity measurements between the upper piston surface 58 and the upper surface of the upper cylinder recess 44, thereby providing a means for determining the angle (pitch and roll) of the piston 24 relative to the cylinder 22.

The controller 70 is configured to dynamically modify the mass of the gaseous media within the upper and lower cylinder chambers 40, 42 to equalize the net gas pressure force Fₚᵣₑₛₛᵤᵣₑ. In the illustrated embodiment, the amount of mass to be added or subtracted from the cylinder chambers 40, 42 will be determined based on the proximity measurements of the sensors 84, and ultimately, the displacement between the piston 24 and cylinder 22 from the initial equilibrium point, as will be described in further detail below. Significantly, the controller 70 can equalize the net gas pressure force Fₚᵣₑₛₛᵤᵣₑ based on pressure measurements made within the cylinder chambers 40, 42. However, due to pressure gradients within the cylinder chambers 40, 42, the pressure measurements acquired from the cylinder chambers 40, 42 may be inaccurate, whereas proximity measurements taken between the piston 24 and cylinder 22 (and thus, displacement between the piston 24 and cylinder 22) have been found to be highly accurate in determining the gas pressure within each of the cylinder chambers 40, 42.

The controller 70 may increase the mass of the gaseous medium within the upper cylinder chamber 40 by opening a valve 86 on the high pressure conduit 76, while maintaining a valve 90 on the low pressure conduit 80 closed, so that the gaseous medium in the high pressure tank 72 is conveyed through the conduit 76 into the upper cylinder chamber 40. Similarly, the controller 70 may increase the mass of the gaseous medium within the lower cylinder chamber 42 by opening a valve 88 on the high pressure conduit 78, while maintaining a valve 92 on the low pressure conduit 82 closed, so that the gaseous medium in the high pressure tank 72 is conveyed through the conduit 78 into the lower cylinder chamber 42.

In contrast, the controller 70 may decrease the mass of the gaseous medium within the upper cylinder chamber 40 by opening the valve 90 on the low pressure conduit 80, while maintaining the valve 86 on the high pressure conduit 72 closed, so that the gaseous medium in the upper cylinder chamber 40 is conveyed through the conduit 80 into the low pressure tank 74. Similarly, the controller 70 may decrease the mass of the gaseous medium in the lower cylinder chamber 42 by opening a valve 92 on the low pressure conduit 82, while maintaining the valve 88 on the high pressure conduit 76 closed, so that the gaseous medium in the lower cylinder chamber 42 is conveyed through the conduit 82 into the low pressure tank 74.

In practice, the controller 70 will typically increase the mass of the gaseous medium in one of the upper and lower cylinder chambers 72, 74, while decreasing gas mass in the other of the upper and lower cylinder chambers 72, 74. Thus, the controller 70 will either simultaneously open the valves 86, 92 on the respective high and low pressure conduits 76, 82 to convey the gaseous medium into the upper cylinder chamber 40 and convey the gaseous medium out of the lower cylinder chamber 42, or will simultaneously open the valves 88, 90 on the respective high and low pressure conduits 78, 80 to convey the gaseous medium into the lower cylinder chamber 42 and convey the gaseous medium out of the upper cylinder chamber 40. It should also be noted that the control subsystem 20 can be designed, such that each valve can be toggled between a “fully on” or “fully off” position by sending or not sending electrical current to the respective valve, or can be designed, such that each valve can be operated to control the flow rate of the gaseous medium through the respective conduits 76-82 by adjusting the magnitude of electrical current sent to the respective valve to vary the flow rate of the gaseous medium.

In the illustrated embodiment, the static equilibrium point of the gas spring 18 is set, such that the net gas pressure force on the piston 24 is equal to the weight of the payload 12 (again ignoring the insubstantial weight of the piston 24). Notably, making the net gas pressure force on the piston 24 equal to the weight of the payload 12 ensures that payload 12 will stabilize along the z-axis of the inertial reference frame when the net gas pressure force is subsequently equalized, as explained below. Equating the net gas pressure force on the piston 24 to the weight of the payload 12 provides:

Fₚᵣₑₛₛᵤᵣₑ=Fₗₛ−Fᵤₛ=APₗₛ−APᵤₛ=M_{payload}g, [4]

where Fₚᵣₑₛₛᵤᵣₑ is the net gas pressure force on the piston 24; Fₗₛ is the gas pressure force on the piston 24 from the lower cylinder chamber 42 at initial static equilibrium; Fᵤₛ is the gas pressure force on the piston 24 from the upper cylinder chamber 40 at initial static equilibrium; A is the area of each of the upper and lower surfaces ?, ? of the piston 24 (ignoring the loss of area of the lower surface 60 due to the piston shaft 68); Pₗₛ is the gas pressure in the lower cylinder chamber 42 at initial static equilibrium; Pᵤₛ is the gas pressure in the upper chamber at initial static equilibrium; M_{payload} is the mass of the payload 12; and g is the acceleration due to gravity.

Rearranging equation [3], the upper and lower cylinder chambers 40, 42 may be initially pressurized in accordance with the following equation, so that the net gas pressure force Fₚᵣₑₛₛᵤᵣₑ supports the entire weight of the payload 12:

$$Δ P = {P}_{ls} - {P}_{us} = [ \frac{{M}_{payload} g}{A} ] , \qquad [ 5 ]$$

where ΔP is the pressure differential across the piston 24.

One can make an assumption of the gas pressure in the upper and lower cylinder chambers 40, 42 based on design considerations or arbitrarily. For a circular piston head with a 200 cm diameter that supports a payload mass of 1000 kg, and assuming that the gaseous media in each of the cylinder chambers 40, 42 is air, the pressure differential across the piston 24 is approximately 3 atmospheres.

In one method, the mass of the payload 12 is temporarily supported to decouple its force from the piston 24, and each of the upper and lower cylinder chambers 40, 42 is pressurized with gas at atmospheric pressure. The mass of the payload 12 is then slowly released onto the piston 24; i.e., the support previously supporting the mass of the payload 12 is slowly taken away, until the piston 24 normalizes to an initial position within the cylinder 22, so that the upper cylinder chamber 40 has a height hᵤₛ, and the lower chamber has a height hₗₛ. At this initial static equilibrium point, the upper and lower chambers 40, 42 will have different gas pressures, with the gas pressure in the lower cylinder chamber 42 being greater than 1 atmosphere, and the gas pressure in the upper cylinder chamber 40 being less than 1 atmosphere, which applies a net gas pressure force to the piston 24 equal to the weight of the payload 12.

As an alternative to allowing the weight of the payload 12 to set the static equilibrium point of the gas spring 18, the upper and lower chambers 40, 42 can be pre-pressurized, such that equation [5] is satisfied. For example, 1 atmosphere of pressure can be assumed for the upper cylinder chamber 40, while equation [4] can be rearranged as follows to determine the gas pressure of the lower cylinder chamber 42 required to support the weight of the payload 12:

$${P}_{l} = \frac{{M}_{payload} g + {AP}_{u}}{A} \qquad [ 6 ]$$

In this case, the initial position of the piston 24 relative to the cylinder 22 can be physically set, so that the upper cylinder chamber 40 has a height hᵤₛ, and the lower chamber has a height his, and a gaseous medium is added to the lower cylinder chamber 42 until the gas pressure has reached the value dictated in equation [6]. Notably, this alternative method allows the heights hᵤₛ, hₗₛ, of the respective upper and lower chambers 40, 42 to be set equal, so that the piston 24 is centered within the upper cylinder recess 44. The payload 12 can then be mounted to the piston 24, or if already mounted, the mass of the payload 12 may be released onto the piston 24.

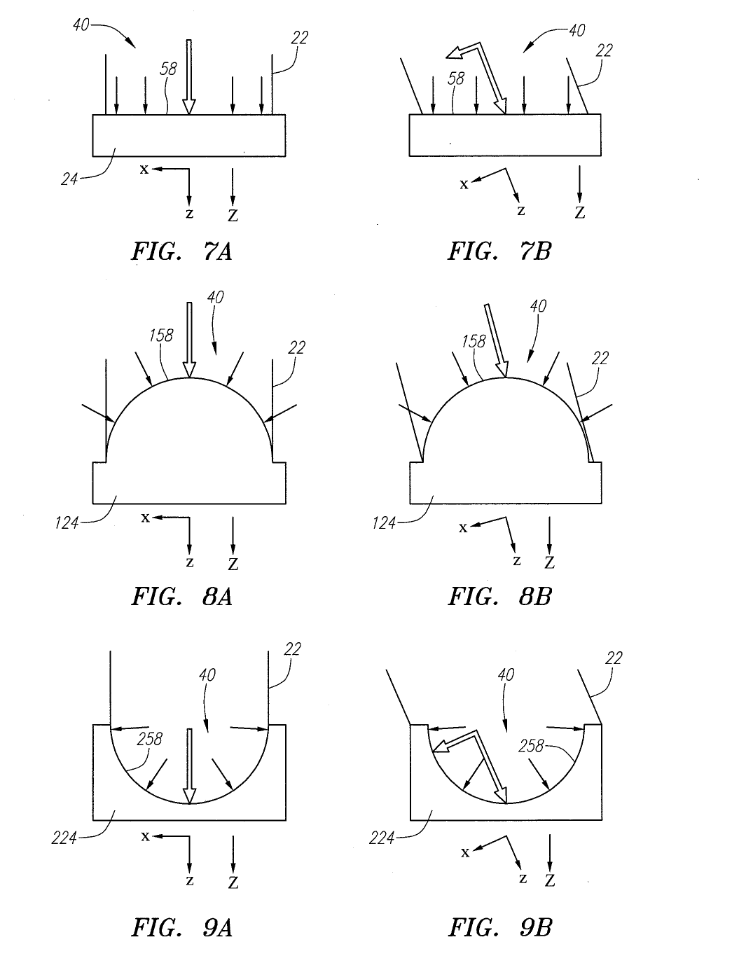

Notably, if both of the cylinder chambers 40, 42 are initially pressurized above atmospheric pressure, the pressure differential across the membrane that contains the MR fluid in the piston gasket 28 will cause the membrane to bulge inward towards the MR fluid (assuming that the MR fluid is at atmospheric pressure)—a safer arrangement than if the membrane is bulging out, which would occur if any one of the cylinder chambers 40, 42 was below atmospheric pressure. In addition, if a concave piston, such as the piston 224 illustrated in FIG. 6, is used, a more corrective restoring force is applied, thereby creating more stabilization for the piston 24 relative to the cylinder 22.

In the illustrated embodiment, the controller 70 determines the mass of gas to be introduced into or removed from the upper and lower cylinder chambers 40, 42 based on the relative displacement of the piston 24 and cylinder 22 from the static equilibrium point, such that the net gas pressure force on the piston 24 is equalized. Given a displacement z between the piston 24 and cylinder 22 from the initial relative position of the piston 24 and cylinder 22, the mass of gas to be introduced into or removed from the respective chambers 40, 42 to equalize the net gas pressure force Fₚᵣₑₛₛᵤᵣₑ on the payload 12, can be determined using the Ideal Gas Law:

PV=mRT, [7]

where P is the pressure in the chamber in absolute scale in Pascals; V is the volume of the chamber in meters³; m is the mass of gaseous medium in the chamber in kilograms; R is the gas constant in J/kg/K; and T is the temperature in degrees Kelvin, and is constant given isothermal assumptions.

The net gas pressure force can then be expressed as follows:

$$\begin{matrix}{F}_{pressure} = {F}_{lower} - {F}_{upper} \\ = {P}_{lower} A - {P}_{upper} A \\ = \frac{{m}_{lower} RT}{{h}_{ls} + z} - \frac{{m}_{upper} RT}{{h}_{us} - z}\end{matrix} \qquad [ 8 ]$$

where F_{lower} is the gas pressure force applied to the lower piston surface 60, Fᵤₚₚₑᵣ is the gas pressure force applied to the upper piston surface 58, P_{lower} is the gas pressure in the lower cylinder chamber 42, Pᵤₚₚₑᵣ is the gas pressure in upper cylinder chamber 40, M_{lower} is the mass of the gas in the lower cylinder chamber 42, mᵤₚₚₑᵣ is the mass of the gas in the upper cylinder chamber 40, and the remaining parameters have been previously defined. Thus, equation [8] can be solved to determine the masses of gas mᵤₚₚₑᵣ, m_{lower} that should be in the upper and lower cylinder chambers 40, 42 to equalize the net gas pressure force Fₚᵣₑₛₛᵤᵣₑ acting on the piston 24 given a relative displacement z between the piston 24 and cylinder 22.

As previously described, the controller 70 is capable of modifying the masses of gas mᵤₚₚₑᵣ, m_{lower} in both of the upper and lower chambers 40, 42. Assuming that this is the case, equation [8] is not strictly deterministic, since mass can be added to the lower cylinder chamber 42 or removed from the upper cylinder chamber 40, or mass can be subtracted from the lower cylinder chamber 42 or added to the upper cylinder chamber 40, to achieve the same result; i.e., to equalize the net gas pressure force Fₚᵣₑₛₛᵤᵣₑ. The masses of gas mᵤₚₚₑᵣ, m_{lower} in the upper and lower cylinder chambers 40, 42 are preferably modified independently by equalizing the gas pressures Pᵤₚₚₑᵣ, P_{lower} in the respective upper and lower chambers 40, 42 (i.e., the gas pressure Pᵤₚₚₑᵣ equals the static equilibrium gas pressure Pᵤₛ, and the gas pressure P_{lower} equals the static equilibrium gas pressure Pₗₛ). Thus, in this case, the mass of the gaseous media mᵤₚₚₑᵣ, m_{lower} that should be in the upper and lower chambers 40, 42 (i.e., the command gas masses), given the relative displacement z, can be determined by rearranging the Ideal Gas Law as:

$$\begin{matrix}{m}_{upper} = \frac{{P}_{us} {V}_{upper}}{RT} = \frac{{P}_{us} A ( {h}_{us} - z )}{RT} ; and & [ 9 ] \\ {m}_{lower} = \frac{{P}_{ls} {V}_{lower}}{RT} = \frac{{P}_{ls} A ( {h}_{ls} + z )}{RT} , & [ 10 ]\end{matrix}$$

where Vᵤₚₚₑᵣ is the volume of gas in the upper cylinder chamber 40, V_{lower} is the volume of gas in the lower cylinder chamber 42, and the remaining terms have previously been defined.

While it is sufficient to only actively control the mass of gas in one of the upper and lower chambers 40, 42 to equalize the net gas pressure force Fₚᵣₑₛₛᵤᵣₑ, redundancy is built into the gas spring 18 by controlling both the upper and lower chambers 40, 42. That is, if one of the cylinder chambers 40, 42 fails, the net gas pressure force Fₚᵣₑₛₛᵤᵣₑ may still be equalized. For example, if the upper cylinder chamber 40 fails by venting all of its gas to atmosphere, the net gas pressure force Fₚᵣₑₛₛᵤᵣₑ can still be equalized by modifying (increasing) the mass of the gaseous medium mower within the lower cylinder chamber 42. If the lower cylinder chamber 42 fails by venting all of its gas to atmosphere, the net gas pressure force Fₚᵣₑₛₛᵤᵣₑ by modifying (decreasing) the mass of the gaseous medium mᵤₚₚₑᵣ within the upper cylinder chamber 40, as long as the net gas pressure force Fₚᵣₑₛₛᵤᵣₑ to be equalized is below one atmosphere.

In an alternative embodiment, only one of the cylinder chambers 40, 42 is controlled; that is, the mass of the gaseous medium in the controlled chamber is modified to maintain the net gas pressure force Fₚᵣₑₛₛᵤᵣₑ. In this manner, less mechanical work is needed, although chamber redundancy is lost. In this case, equation [8] will be deterministic, because the mass of the gaseous medium in the chamber that is not controlled will remain constant. The mass of the gaseous medium that should be in the controlled chamber, given the relative displacement z, can be determined by rearranging the Ideal Gas Law to first determine the gas pressure in the non-controlled chamber as:

$${P}_{upper} = \frac{{m}_{us} RT}{{V}_{upper}} = \frac{{m}_{us} RT}{A ( {h}_{us} - z )} , \qquad [ 11 ]$$

if the non-controlled chamber is the upper chamber; or

$${P}_{lower} = \frac{{m}_{ls} RT}{{V}_{lower}} = \frac{{m}_{ls} RT}{A ( {h}_{ls} + z )} , \qquad [ 12 ]$$

if the non-controlled chamber is the lower chamber,

where Pᵤₚₚₑᵣ is the gas pressure in the upper cylinder chamber 40, P_{lower} is the gas pressure in the lower cylinder chamber 42, mᵤₛ is the mass of gas in the upper chamber at initial static equilibrium, Iᵤₛ is the mass of gas in the lower chamber at initial static equilibrium, and the remaining terms have been previously defined.

The gas pressure that should be in the actively-controlled chamber can then be calculated using the following equations:

Fₚᵣₑₛₛᵤᵣₑ=F_{lower}−Fᵤₚₚₑᵣ=P_{lower}A−PᵤₚₚₑᵣA=M_{payload}g; [13]

$${P}_{upper} = \frac{{m}_{upper} RT}{{V}_{upper}} = \frac{{m}_{upper} RT}{A ( {h}_{us} - z )} , \qquad [ 14 ]$$

if the actively controlled chamber is the upper chamber; and

$${P}_{lower} = \frac{{m}_{lower} RT}{{V}_{lower}} = \frac{{m}_{lower} RT}{A ( {h}_{ls} + z )} , \qquad [ 15 ]$$

if the actively controlled chamber is the lower chamber.

If the actively controlled chamber is the upper chamber, and the non-controlled chamber is the lower chamber, the mass of the gaseous medium mᵤₚₚₑᵣ that should be in the upper chamber (i.e., the commanded mass), given the relative displacement z, can be determined by substituting respective gas pressures of equations [11] and [14] into equation [13]:

$${m}_{upper} = \frac{{m}_{ls} ( {h}_{us} - z )}{( {h}_{ls} + z )} - \frac{Mg ( {h}_{us} - z )}{RT} . \qquad [ 16 ]$$

If the actively controlled chamber is the lower chamber, and the non-controlled chamber is the upper chamber, the mass of the gaseous medium m_{lower} that should be in the lower chamber (i.e., the commanded mass), given the relative displacement z, can be determined by substituting the respective gas pressures of equations [12] and [15] into equation [13]:

$${m}_{lower} = \frac{Mg ( {h}_{ls} + z )}{RT} + \frac{{m}_{us} ( {h}_{ls} + z )}{( {h}_{us} - z )} \qquad [ 17 ]$$

In still another alternative embodiment, a hybrid of the two previous embodiments can be utilized. In particular, during normal operating condition, only one of the cylinder chambers 40, 42 is actively controlled, but both are capable of being controlled at any given time. In this case, the life of the pressure conduit valves can be extended by alternating active control between the cylinder chambers 40, 42. In addition, maintenance can be performed on the pressure conduit valves to one of the cylinder chambers 40, 42, while allowing active control of the other of the cylinder chambers 40, 42, so that the system 10 need not be taken offline. Additionally, if one of the cylinder chambers 40, 42 fails, the other can immediately be used as the actively-controlled chamber.

It should be appreciated that the use of two chambers in a gas spring that can either be controlled simultaneously or alternately, not only provides redundancy to the gas spring 18, but also allows the gas spring 18 to be oriented in any manner, e.g., upside down without requiring any physical or structural modification. However, if redundancy or independent orientation is not desired, the gas spring 18 may be designed within only one chamber on one side of the piston 24, with the other side of the piston exposed to atmospheric pressure. Presumably, the single chamber can be the lower cylinder chamber 42, although the single chamber can be the upper cylinder chamber 40 if the desired pressure differential across the piston 24 is less than atmospheric pressure and the upper cylinder chamber 40 is evacuated.

In this case of a single-chamber design, the mass of the gaseous medium that should be in the actively-controlled chamber, given the relative displacement z, can be determined using the following equations:

Fₚᵣₑₛₛᵤᵣₑ=P_{lower}A−PₐₜₘA=M_{payload}g, if the chamber is a lower chamber; and [18]

Fₚᵣₑₛₛᵤᵣₑ=PₐₜₘA−PᵤₚₚₑᵣA=M_{payload}g, if the chamber is an upper chamber. [19]

If the chamber is the lower chamber, the mass of the gaseous medium m_{lower} that should be in the lower chamber (i.e., the commanded mass), given the relative displacement z, can be determined by substituting the gas pressure of equation [15] into equation [18]:

$${m}_{lower} = \frac{{M}_{payload} g + {P}_{aim} A ( {h}_{ls} + z )}{RT} \qquad [ 20 ]$$

If the chamber is the upper chamber, the mass of the gaseous medium mᵤₚₚₑᵣ that should be in the upper chamber (i.e., the commanded mass), given the relative displacement z, can be determined by substituting gas pressure of equation [14] into equation [19]:

$${m}_{upper} = \frac{{P}_{at m} A ( {h}_{ls} - z ) - {M}_{payload} g}{RT} \qquad [ 21 ]$$

Once the controller 70 modifies the mass of the gaseous medium within one or both of the cylinder chambers 40, 42 in accordance with any of the methods described above, the static equilibrium point of the gas spring 18 is reset; i.e., during a steady state condition, the relative displacement between the piston 24 and the cylinder 22 will be equal to z. Notably, while the static equilibrium point of the gas spring 18 is reset after modifying the mass of the gaseous medium with one or both of the cylinder chambers 40, 42, the controller 70 continuously computes the modification of gas mass in the cylinder chambers 40, 42 based on the initial equilibrium point of the gas spring 18.

Once the commanded masses are computed for either or both of the cylinder chambers 40, 42 (depending on the particular implementation), the change in the mass of the gaseous medium that should be added or subtracted from the respective cylinder chambers 40, 42 to equalize the net gas pressure force Fₚᵣₑₛₛᵤᵣₑ can be computed using the following equations:

Δmᵤₚₚₑᵣ=mᵤₚₚₑᵣ−mᵤₛ; and [22]

Δm_{lower}=m_{lower}−mₗₛ, [23]

where Δmᵤₚₚₑᵣ is change in the mass of the gaseous medium contained in the upper cylinder chamber 40; and Δm_{lower} is change in the mass of the gaseous medium contained in the lower cylinder chamber 40.

Based on the computed mass changes for either or both of the cylinder chambers 40, 42, the controller 70 determines the period of time required to turned on the conduit valves 86-92, and if variable, the magnitude of the electrical current delivered to the valves 86-92, to effect the commanded mass of the gaseous media contained within the upper and lower cylinder chambers 40, 42. The controller 70 may, e.g., calculate the “on-time” of the valves and, if necessary, the magnitude of the electrical current, based on the valve specifications.

While the controller 70 may compute the commanded gas mass, gas mass change, on-time of the valves, and magnitude of the electrical current using any of a variety of mathematical techniques and/or look-up tables. Preferably, the controller 70 will input the relative displacement z between the piston 24 and cylinder 22 into the desired equations set forth above to obtain the desired mass change of the gaseous media in the cylinder chambers 40, 42, and then input the desired mass change into an equation or look-up table to obtain the “on-time” of the valves and magnitude of the electrical current that varies the flow-rate of the valves. Alternatively, computation of the mass of the gaseous media in the cylinder chambers 40, 42 may be obviated by using an equation or look-up table that outputs the “on-time” of the valves and magnitude of the electrical current in response to an input of the relative displacement z between the piston 24 and cylinder 22.

It should be noted that, while the controller 70 continually computes the mass of the gaseous media to be modified within the cylinder chambers 40, 42 based on the relatively displacement of the piston 24 and cylinder 22, the controller 70 determines whether to actually modify the mass of the gaseous medium in the cylinder chambers 40, 42 (via operation of the conduit valves) based on the velocity of the piston 24 relative to the cylinder 22 (as determined by the proximity measurements taken from the sensors 84). These determinations can be performed periodically based on the maximum expected frequency of the vibrations within the floor 14. For example, if the maximum expected frequency is 30 Hz, it may be sufficient to periodically determine the mass of the gaseous media to be modified in the cylinder chambers 40, 42, and whether to actually make such modification, every 10 ms. Notably, the velocity can be measured by obtaining the proximity measurements from the sensors 84 to determine a relative displacement of the piston 22 over a period of time. Thus, in the illustrated embodiment, the velocity is an average velocity, as opposed to an instantaneous velocity—although there are means available for measuring an instantaneous velocity that can be used by the controller 70.

In either case, the controller 70 computes the absolute value of the relative velocity divided by the maximum expected velocity (a constant that is set by the user) to determine a velocity ratio. If the velocity ratio is between a predetermined lower threshold and a predetermined upper threshold (constants that are set by the user) the mass of the gaseous media within the cylinder chambers 40, 42 are modified in accordance with the commanded gas masses. If the velocity ratio is less than the predetermined lower threshold, the piston 24 is moving too slowly relative to the cylinder 22, and therefore, the previous gas masses in the cylinder chambers 40, 42 are maintained. If the velocity ratio is greater than the predetermined higher threshold, the piston 24 is moving too quickly relative to the cylinder 22, in which case, there is a danger that the piston 24 will run into the rails of the upper cylinder recess 44. In this case, the static equilibrium point of the gas spring 18 should not be reset in order to allow the spring constant of gas spring 18 to dampen the vibrations.

Referring back to FIG. 2, as briefly discussed above, the piston gasket 28, and optionally the rod gasket 30, takes the form of a magneto-rheological (MR) fluid gasket that includes a thin membrane that contains an MR fluid. MR fluid responds to a magnetic field with a dramatic change in rheological behavior. MR fluids have different viscoelastic properties when exposed to different magnetic field strengths. Thus, MR fluids can reversibly and instantaneously change from a free-flowing liquid (primarily viscous) (e.g., viscosity values similar to those of motor oil (about 8 PaS)) to a semi-solid (primarily elastic) with controllable yield strength when exposed to a given magnetic field strength. When no magnetic field is applied to the MR fluid gasket, the viscous component is several orders of magnitude higher than the elastic component, making the MR fluid gasket acts as a pure damper. When a magnetic field of sufficient magnitude is applied to the MR fluid gasket, the MR fluid reacts as a viscoelastic material, making the fluid gasket as a spring-damper.

The geometry of the MR gasket is based on the interaction with the piston 24 and the required viscoelastic properties for proper system behavior. The geometry of the MR gasket will be an optimization of these parameters, along with such considerations as size and weight. The MR fluid preferably has a high spring and a high damping constant, which are both functions of geometry and fluid properties. Preferably, the membrane that contains the MR fluid is continually slack, so that the membrane itself does not impart a force. Latex is a suitable material from which the membrane can be composed.

The damping force applied by the MR fluid gasket can be expressed as:

$$\begin{matrix}F = - cv , & [ 22 ] \\ c = 2 π \frac{L}{δ} η & [ 23 ]\end{matrix}$$

where F is the damping force applied by the MR fluid gasket, c is the damping coefficient of the MR fluid, and v is the velocity of the piston 24 relative to the cylinder 22, R is the radius of the piston 24, L is the height of the piston 24, δ is the size of the gap between the piston 24 and the cylinder side wall 32, and η is the viscosity of the fluid dependent on the magnetic field strength.

The spring force applied b the MR fluid gasket can be expressed as:

$$\begin{matrix}F = - kx & [ 24 ] \\ k = \frac{GA}{l} , & [ 25 ]\end{matrix}$$

where G is the storage modulus of the fluid depending on the frequency of the piston 24 (relative to the cylinder 22) for some magnetic field levels, A is the area of the piston surface exposed to the fluid, and l is the distance between the top of the piston surface and the top of the upper cylinder recess 44.

The controller 70 operates an electromagnet 94 to apply or not apply the magnetic field based on the relative displacement and velocity between the piston 24 and cylinder 22, as computed from the proximity measurements of the sensors 84. Assuming that the system 10 is presently operating in a “normal mode,” the controller 70 will declare an “operational fault condition” if the absolute value of the relative displacement z exceeds a predetermined threshold; that is, the piston 24 is too close to the rails of the upper cylinder recess 44 or when the absolute value of the relative velocity between the piston 24 and cylinder 22 exceeds a predetermined threshold; that is, there is a danger that the velocity of the piston 24 may carry it into the rails of the upper cylinder recess 44. The controller 70 assumes that the relative displacement between the piston 24 and cylinder 22 is zero (i.e., z=0) when the piston 24 is centered within the upper cylinder recess 44. In response to the operational fault condition, the controller 70 applies a magnetic field to the MR fluid gasket 28 via the electromagnet 94, thereby transforming the MR fluid gasket 28 from a primarily viscous mechanism into a primarily elastic mechanism that will prevent the piston 24 from contacting the rails of the upper cylinder recess 44 (or the rod flange 66 from contacting the rails of the lower cylinder recess 48). During an operational fault condition, the controller 70 may also transmit an alarm signal to alert the user that the system is operating in a fault mode.

Assuming that the system 10 is presently operating in a “fault mode,” the controller 70 will declare an “operational normal condition” if both the absolute value of the relative displacement z is less than a predetermined threshold (which may be the same as the fault condition threshold or may be less than the fault condition threshold to provide hysteresis); that is, the piston 24 is far enough away from rails of the upper cylinder recess 44 and when the absolute value of the relative velocity between the piston 24 and cylinder 22 is less than a predetermined threshold (which may be the same as the fault condition threshold or may be less than the fault condition threshold to provide hysteresis); that is, there is no danger that the velocity of the piston 24 will carry it into contact with the rails of the upper cylinder recess 44. In response to the operational fault condition, the controller 70 applies a magnetic field to the MR fluid gasket 28 via the electromagnet 94, thereby transforming the MR fluid gasket 28 from a primarily elastic mechanism into a primarily viscous mechanism that will allow the piston 24 to move more freely between the rails of the upper cylinder recess 44 (or the rod flange 66 to move more freely between the rails of the lower cylinder recess 48).

Although particular embodiments of the present invention have been shown and described, it should be understood that the above discussion is not intended to limit the present invention to these embodiments. It will be obvious to those skilled in the art that various changes and modifications may be made without departing from the spirit and scope of the present invention. Thus, the present invention is intended to cover alternatives, modifications, and equivalents that may fall within the spirit and scope of the present invention as defined by the claims.

What is claimed is:

1. A gas spring, comprising:
a housing; and
a piston disposed within the housing, the piston configured to be displaced relative to the housing in response to a vibration applied to the housing, the piston having a first concave surface and a second surface opposing the first concave surface, the housing configured to allow a first gaseous medium to apply a first gas pressure to the first concave piston surface, and a second gaseous medium to apply a second gas pressure to the second piston surface, thereby resulting in a net gas pressure force applied to the piston.

2. The gas spring of claim 1, wherein the piston is cylindrical.

3. The gas spring of claim 1, wherein the housing has a first chamber adjacent the first concave piston surface, and a second chamber adjacent the second piston surface.

4. The gas spring of claim 1, wherein the concave surface is spherical.

5. The gas spring of claim 1, wherein the concave surface is lens-shaped.

6. The gas spring of claim 1, wherein the second piston surface is concave.

7. A vibration suppression system, comprising:
the gas spring of claim 1; and
a payload mechanically coupled to the piston of the gas spring.

8. The vibration suppression system of claim 7, wherein the payload comprises one or more components of manufacturing equipment.

9. The vibration suppression system of claim 7, wherein the housing has a first chamber adjacent the first piston surface for containing the first gaseous medium, and further comprising a pressure control subsystem configured to modify the mass of the first gaseous medium within the first chamber to equalize the net gas pressure force when modified in response to a displacement of the piston relative to the housing.

10. A gas spring, comprising:
a housing; and
a piston disposed within the housing, the piston configured to be displaced relative to the housing in response to a vibration applied to the housing, the piston having a first convex surface and a second surface opposing the first convex surface, the housing configured to allow a first gaseous medium to apply a first gas pressure to the first concave piston surface, and a second gaseous medium to apply a second gas pressure to the second piston surface, thereby resulting in a net gas pressure force applied to the piston.

11. The gas spring of claim 10, wherein the piston is cylindrical.

12. The gas spring of claim 10, wherein the housing has a first chamber adjacent the first convex piston surface, and a second chamber adjacent the second piston surface.

13. The gas spring of claim 10, wherein the convex surface is spherical.

14. The gas spring of claim 10, wherein the convex surface is lens-shaped.

15. The gas spring of claim 10, wherein the second piston surface is convex.

16. A vibration suppression system, comprising:
the gas spring of claim 10; and
a payload mechanically coupled to the piston of the gas spring.

17. The vibration suppression system of claim 16, wherein the payload comprises one or more components of manufacturing equipment.

18. The vibration suppression system of claim 17, wherein the housing has a first chamber adjacent the first piston surface for containing the first gaseous medium, and further comprising a pressure control subsystem configured to modify the mass of the first gaseous medium within the first chamber to equalize the net gas pressure force when modified in response to a displacement of the piston relative to the housing.
